(19) United States
(12) Patent Application Publication
(10) Pub. No.: US 2025/0361888 A1
(43) Pub. Date: Nov. 27, 2025

(54) LINEAR ACTUATOR WITH ENERGY RECUPERATION CAPABILITY

(71) Applicant: Purdue Research Foundation, West Lafayette, IN (US)

(72) Inventors: Lizhi Shang, West Lafayette, IN (US); Andrea Vacca, West Lafayette, IN (US)

(73) Assignee: Purdue Research Foundation, West Lafayette, IN (US)

(21) Appl. No.: 19/186,521

(22) Filed: Apr. 22, 2025

Related U.S. Application Data
(60) Provisional application No. 63/650,227, filed on May 21, 2024.

(51) Int. Cl. F15B 15/14; F15B 1/04

(52) U.S. Cl. CPC F15B 15/14; F15B 1/04

(57) ABSTRACT

An actuator includes a housing, an assist cylinder at least partially disposed within the housing and configured to provide rectilinear motion with respect to the housing, the assist cylinder is configured to be coupled to a load to be moved, a screw at least partially disposed within the assist cylinder and rotatably coupled to a ball-nut, such that rotation of the screw in a causes the assist cylinder to advance forward and retract backward, a prime drive having an output that is coupled to the screw and configured to rotate the screw, and an assist drive fluidly coupled to the assist cylinder and configured to provide an assist fluid having an assist pressure against a cross sectional area of the assist cylinder to thereby generate an assist force to assist moving the assist cylinder.

### CROSS-REFERENCE TO RELATED APPLICATIONS

The present non-provisional patent application is related to and claims the priority benefit of U.S. Provisional Patent Application Ser. 63/650,227, filed May 21, 2024, the contents of which are hereby incorporated by reference in its entirety into the present disclosure.

### STATEMENT REGARDING GOVERNMENT FUNDING

None.

### TECHNICAL FIELD

The present disclosure generally relates linear electromechanical and hydromechanical actuators and in particular to actuators with energy recuperation capabilities in example fields of off-road vehicle working functions: construction, agriculture, mining; industrial applications; electric vehicle applications; as well as aerospace application.

### BACKGROUND

This section introduces aspects that may help facilitate a better understanding of the disclosure. Accordingly, these statements are to be read in this light and are not to be understood as admissions about what is or is not prior art.

Linear actuators are used in a large variety of applications including sustainable off-road vehicles (ORVs) used for construction, material handling, and agriculture, as well as electric vehicles (EVs) or vehicle powered by low-carbon fuels including hydrogen, propane, natural gas, and diethyl ether. Generally, each of these applications need more energy efficient actuation technology than conventional electromechanical or hydromechanical actuation to reduce the total cost of ownership (TCO), reduce in-vehicle energy storage requirement, and maximize reduction of greenhouse gas (GHG) and criteria emissions. However, the actuators of the prior art have had challenges meeting these requirements.

In U.S. Pat. No. 11,852,173 to Hussain et al. a screw pump type electro-hydraulic actuator is disclosed. FIG. 6 of the '173 patent is redrawn and reproduced as FIG. 1A which shows an electric motor is operating a bi-directional pump which pressurizes one of two hydraulic chambers and thus places a hydraulic force on a pump piston. An accumulator via valves hydraulically communicates with the two hydraulic chambers. In the '173 patent, the only drive is the hydraulic actuation of the pump piston via hydraulic pressure acting on the surface of the pump piston. The necessity for two hydraulic chambers requires two sets of seals and primary actuation based on hydraulic force on the pump piston.

In U.S. Pat. No. 11,773,949 to Wang et al., an electro-hydraulic linear ball screw actuator is disclosed. FIG. 3 of the '949 patent is redrawn and reproduced herein as FIG. 1B. As in the '173, the prime drive in the '949 patent is a based on hydraulic pressure exerting a force on the piston portion. Additionally, just as in the '173 patent, there are two hydraulic chambers requiring two sets of seals (O-rings), as shown. Thus in both cases (the '173 and '949 patents), the prime drive is hydraulic pressure exerting forces on respective pistons resulting in movement of the pistons. However, both of these cases suffer from having two hydraulic chambers requiring two sets of seals.

Thus, there is an unmet need for a novel approach that allows for integration of new electromechanical and hydromechanical actuators, thus enabling: (i) easy-to-implement throttle-less fluid power (FP) for linear functions through a secondary controlled architectures; (ii) recovery of energy associated to overrunning loads; and (iii) hydraulic “cancellation” of the implement weight—which is often heavier than the payload itself—to downsize the actuation system and energy usage.

### SUMMARY

An actuator is disclosed. The actuator includes a housing, an assist cylinder forming a single hydraulic chamber at least partially disposed within the housing and configured to provide rectilinear motion with respect to the housing, wherein fluid within the assist cylinder is sealed from outside by a seal between the housing and the assist cylinder, the assist cylinder is configured to be coupled to a load to be moved. The actuator further includes a screw disposed within the housing and rotatably coupled to a ball-nut solidly coupled to the assist cylinder, such that rotation of the screw in a first direction causes the assist cylinder to advance forward and rotation of the screw in a second direction opposite the first directions causes the assist cylinder to retract backward. Additionally, the actuator includes a prime drive having an output that is coupled to the screw and configured to rotate the screw in the first and second directions. The actuator also includes an assist drive fluidly coupled to the assist cylinder and configured to provide an assist fluid having an assist pressure against a cross sectional area of the assist cylinder to thereby generate an assist force to assist moving the assist cylinder.

Another actuator is also disclosed. The actuator includes a housing, a screw at least partially disposed within the housing and rotatably coupled to a ball-nut, such that rotation of the screw in a first direction causes the screw to advance forward and rotation of the screw in a second direction opposite the first directions causes the screw to retract backward, the screw is configured to be coupled to a load to be moved, and a prime drive having an output that is coupled to the screw and configured to rotate the screw in the first and second directions, wherein the prime drive is a fluid-based pump or motor with two ports for transference of prime drive fluid.

A load moving system is also disclosed. The moving system includes an actuator and a load coupling interface to a load to be moved. The actuator includes a housing, an assist cylinder forming a single hydraulic chamber at least partially disposed within the housing and configured to provide rectilinear motion with respect to the housing, wherein fluid within the assist cylinder is sealed from outside by a seal between the housing and the assist cylinder, the assist cylinder is configured to be coupled to a load to be moved. The actuator further includes a screw at least partially disposed within the assist cylinder and rotatably coupled to a ball-nut, such that rotation of the screw in a first direction causes the assist cylinder to advance forward and rotation of the screw in a second direction opposite the first directions causes the assist cylinder to retract backward. Additionally, the actuator includes a prime drive having an output that is coupled to the screw and configured to rotate the screw in the first and second directions. The actuator also includes an assist drive fluidly coupled to the assist cylinder and configured to provide an assist fluid having an assist pressure against a cross sectional area of the assist cylinder to thereby generate an assist force to assist moving the assist cylinder.

### BRIEF DESCRIPTION OF FIGURES

FIG. 1A is a schematic of a prior art screw pump type electro-hydraulic actuator.

FIG. 1B is a schematic of a prior art electro-hydraulic linear ball screw actuator.

FIG. 1C is a schematic of a typical linear electromechanical actuator, known in the art.

FIG. 1D is a schematic of a one embodiment according to the present disclosure of a fluid-based hydromechanical actuator wherein a fluid based prime device is configured to rotate a screw within a ball-nut to advance and retract the screw for lifting a load.

FIG. 2 is a schematic of one embodiment according to the present disclosure of an electro-fluid actuator wherein an electrical-based prime drive is configured to rotate a screw within a ball-nut solidly coupled to an assist cylinder to rectilinearly advance and retract the assist cylinder for lifting a load and a fluid-based assist drive is configured to assist.

FIG. 3 is a schematic of the embodiment according to the present disclosure shown in FIG. 2 in an application where the actuator of FIG. 2 is lifting a load wherein the prime drive includes an electric motor and the assist drive is coupled to an accumulator to provide the assist fluid.

FIG. 4 is the schematic of the embodiment according to the present disclosure shown in FIG. 3 with a pressure regulating system inserted between an assist port and an accumulator for improved pressure regulation.

FIG. 5 is a schematic of the embodiment according to the present disclosure shown in FIG. 4 but with an assist flow source instead of the accumulator with an optional pressure regulating system as described with respect to FIG. 4.

FIGS. 6A and 6B are schematics of an embodiment according to the present disclosure wherein a fluid-based prime drive device is configured to rotate a screw within a ball-nut solidly coupled to an assist cylinder to rectilinearly advance and retract the assist cylinder for lifting a load and with assistance of a fluid-based assist drive in retracted and extended positions, respectively.

FIG. 7 is a schematic of the embodiment according to the present disclosure shown in FIGS. 6 and 6B in an application where the actuator is lifting a load wherein the prime drive includes a fluid-based device and the assist drive is coupled to an accumulator to provide the assist fluid.

FIG. 8 is the schematic of the embodiment according to the present disclosure shown in FIG. 7 with a pressure regulating system inserted between an assist port and an accumulator for improved pressure regulation.

FIG. 9 is a schematic of the embodiment according to the present disclosure shown in FIG. 8 but with an assist flow source instead of the accumulator with an optional pressure regulating system.

FIG. 10 is a schematic of the embodiment according to the present disclosure shown in FIGS. 6 and 6B in an application where the actuator is lifting a load wherein the prime drive includes a fluid-based device and the assist drive is coupled to one of the two ports of the prime drive to provide the assist fluid.

FIG. 11 is the schematic of the embodiment according to the present disclosure shown in FIG. 10 with a pressure regulating system inserted between an assist port and one of the two ports of the prime drive to provide the assist fluid.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

A novel approach is presented herein that allows for integration of new electromechanical and hydromechanical actuators, thus enabling: (i) easy-to-implement throttle-less fluid power (FP) for linear functions through a secondary controlled architectures; (ii) recovery of energy associated with overrunning loads; and (iii) hydraulic “cancellation” of the implement weight—which is often heavier than the payload itself—to downsize the actuation system and energy usage.

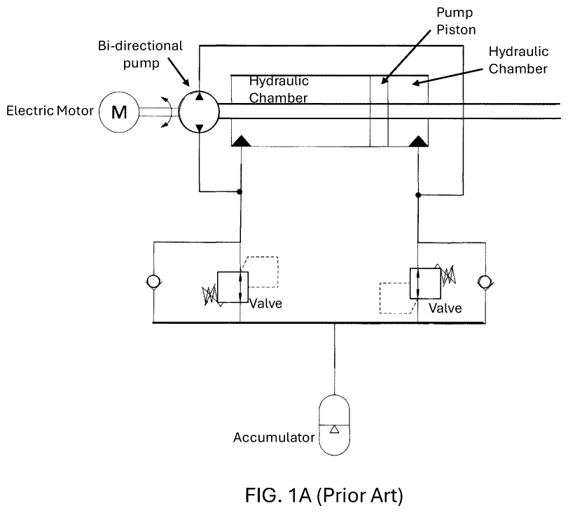

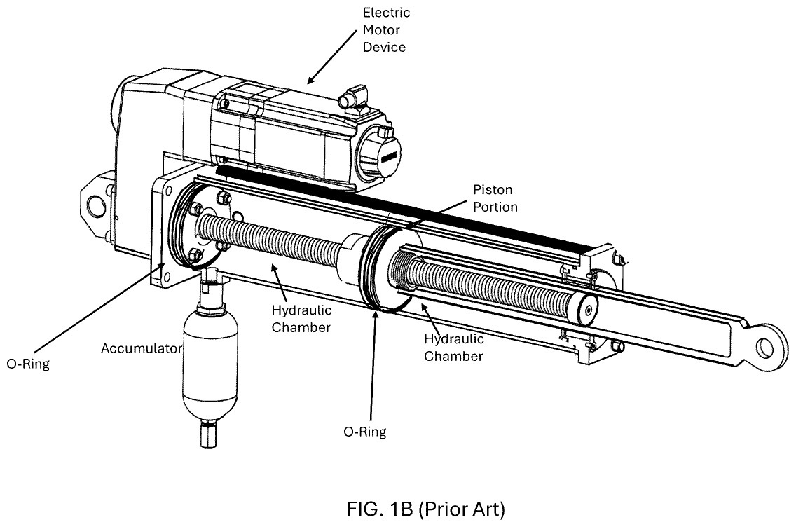

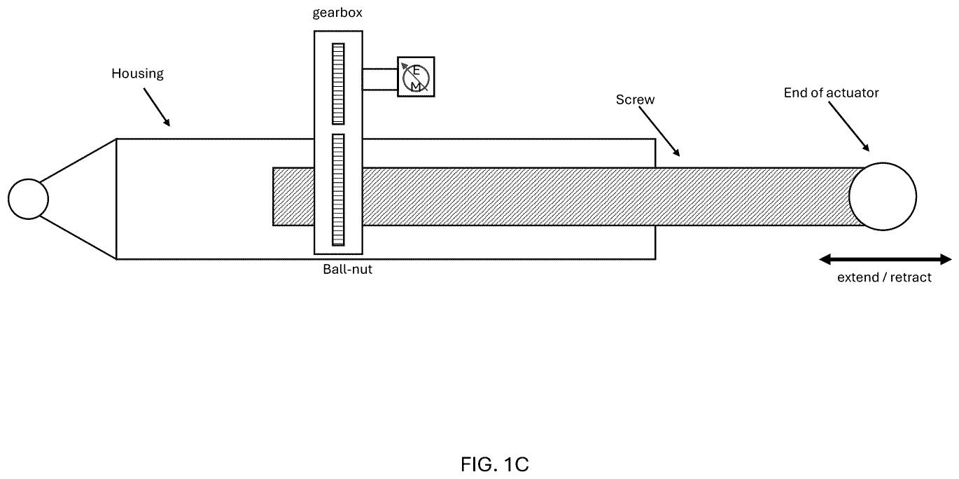

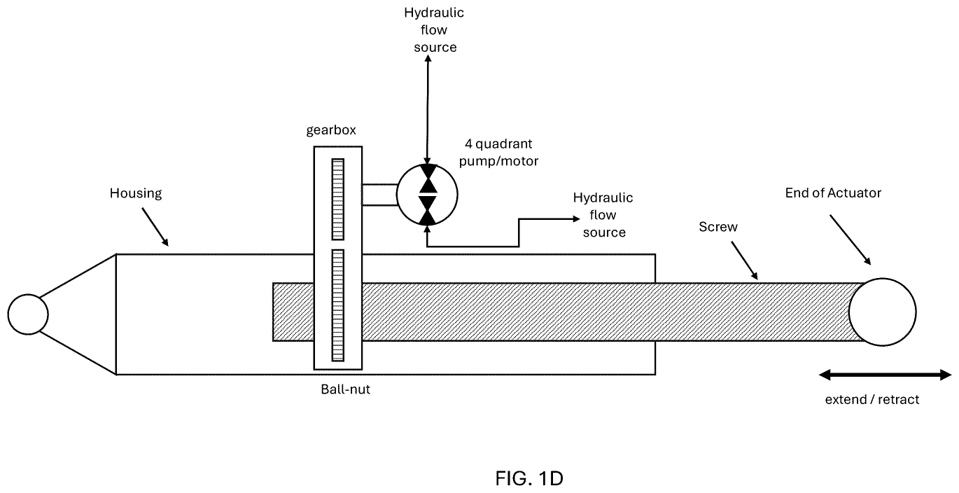

Referring to FIG. 1C, a simplistic schematic of a typical linear electromechanical actuator, known in the art, is shown. The actuator of FIG. 1C, includes a prime drive, e.g., an electric motor, that is coupled to a screw at least partially disposed within a housing via a gearbox or a belt-driven assembly (not shown), such that as the electric motor rotates in a forward direction causes the screw to rectilinearly extend in a respective first direction and while the electric motor rotates in a reverse direction causes the screw to rectilinearly retract in a second direction, opposite the first direction. Thus, in the embodiment shown in FIG. 1C, the prime drive is an electric motor turning a screw in a ball-nut that causes the end of the actuator to move rectilinearly (i.e., extend and retract). The amount of force that the actuator of FIG. 1C can exert onto a load is then dependent on the power of the electric motor as well as any torque amplification by using the appropriate gears or pullies (not shown).

To improve the actuator shown in FIG. 1C, three classes of embodiments are presented herein. The first class, replaces the electric motor in FIG. 1C with a hydraulic pump or motor, e.g., a 4 quadrant pump/motor (a person having ordinary skill in the art appreciates that the difference between a hydraulic pump and a hydraulic motor is that a hydraulic pump converts mechanical energy, e.g., rotatory motion of the pump's shaft that is coupled to the screw, into output hydraulic energy in the form high hydraulic pressure; while a hydraulic motor converts hydraulic energy into mechanical energy thus achieving rotary motion that can turn the screw). The hydraulic pump or motor can be placed inside the housing or outside. Regardless, the hydraulic motor rotates the screw that turns inside a ball-nut, thus advancing or retracting depending on the direction of rotation of the screw. Here the ball-nut is stationary and the screw via rotation in the ball-nut advances or retracts depending on the direction of rotation of the screw thus moving the load. This embodiment is shown in FIG. 1D, where the hydraulic pump or motor is positioned outside of the actuator and it communicates with hydraulic flow sources for forward and reverse operation. It should be appreciated that the embodiment shown in FIG. 1D does not include a hydraulic chamber about the screw. Thus no hydraulic seal is needed to separate the environment inside the housing from outside of the housing. In the embodiment shown in FIG. 1D the hydraulic pump or motor is the prime and the only drive. While the prime drive is shown as a hydraulic pump or motor, a gas-operated prime drive, e.g., a pneumatic pump or motor, may be used instead for smaller load-lifting capabilities.

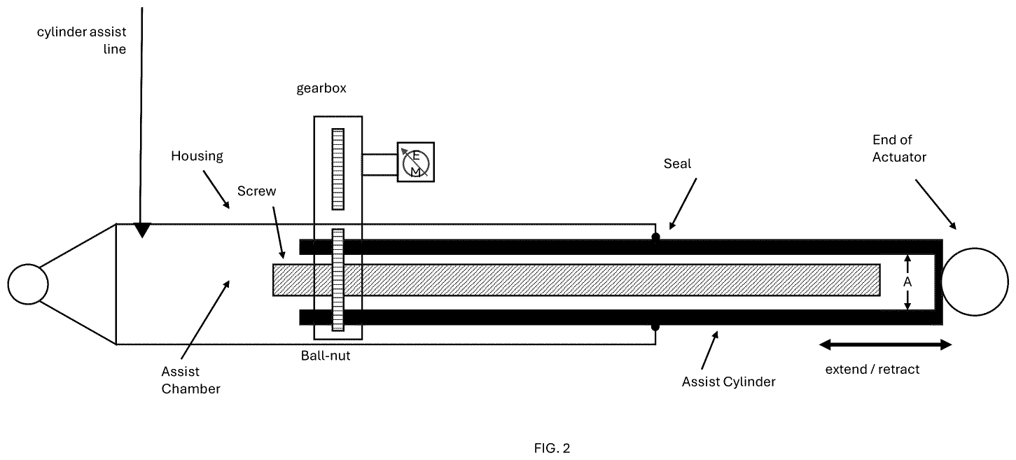

To further improve the embodiment shown in FIG. 1C, the second class of embodiments according to the present disclosure includes an assist port coupled to a cylinder assist line and a single assist chamber requiring only one seal, as shown in FIG. 2, which is a schematic of an improved actuator. This class of embodiments includes an electric motor as in FIG. 1C which is the prime drive and is intended to turn the screw via a gearbox or pullies and belts (not shown). The assist port introduces pressurized fluid into the volume defining the assist chamber inside the housing. The pressurized assist fluid that is provided via the cylinder assist line provides an assist and therefore referred to herein as an assist drive. Thus the prime drive is based on the electric motor turning the screw inside the bull-nut and the assist drive is based on a force generated by the assist pressure acting on the cross-sectional area A. Here the housing includes a stationary end and a moving end. The screw is stationary and a ball-nut and a solidly coupled assist cylinder are rectilinearly moveable. Thus by turning the screw inside the ball-nut, the ball-nut along with the assist cylinder advances or retracts, depending on the direction of rotation of the screw, thus by way of a solid connection (not shown) between the ball-nut and the assist cylinder, the assist cylinder extends or retracts thus allowing movement of the load. The assist cylinder presents a cross-sectional area A to the applied assist pressure P, thus generating an assist force of P·A. It should be noted that the embodiment shown in FIG. 2 only has one assist chamber and thus only one seal.

It should be noted that the assist pressure ranges from 0 Pa to a predetermined upper limit. That is, the assist pressure is not intended to be a negative pressure. Therefore, the assist drive provides an assist force between 0 and a predetermined upper limit based on the predetermined upper limit of the assist pressure multiplied by the cross sectional area A. Therefore, if the prime drive provides between 0 to +/−X Newtons (N) without the assist drive, and the assist drive which provides Y N (e.g., in the case of a non-regulated assist drive), the overall force during extension is X+Y N. However, the same assist force during extension (i.e., activation to lift a load) becomes a resist force during retraction (i.e., during letting a load down). Based on the above example, the retraction force becomes −X+Y N. For example, suppose X is a maximum of 1000 N and Y is also a maximum of 1000 N. Then, during the lifting process the prime and the assist can lift a total of 2000 N. However, during the descent (i.e., retraction of the actuator), the prime drive has to provide −1000 N while the assist drive continues to provide 1000 N to add up to a total of 0 N. If the assist drive provides a constant Y N, then the prime drive may provide a downward sliding force from X N to −X N. In the above example, if 2000 N is needed to lift a load, and an operator wishes to lower the load, if the assist drive continuously provides 1000 N, then the prime drive may be reduced gradually from 1000 N to a value that allows the load to be at the desired level. A gain, without a load the downward gradual reduction during retraction should reach −1000 N. Therefore, the assist drive must be sized so that it does not exceed the retractability of the prime drive. The force balance concept described herein applies to all embodiments wherein there is an assist drive and a prime drive, and thus will not be repeated for other embodiments. Where below the assist drive is based on a regulated force, e.g., by using pressure regulation, the same force balance concepts apply but with an additional variability of pressure regulation of the assist drive.

Furthermore, while not shown, the prime drive may either be equipped with a brake to prevent automatic lifting due to the assist drive when the prime drive is not activated or the prime drive has to provide negative and equal force as the assist force in order to achieve steady state when a load is not present.

It should be understood that for heavy lifting actuators, the fluid is a hydraulic fluid and the pump or motor are hydraulic devices, but for lighter lifting actuators, the fluid can be gas, e.g., based on pneumatic devices. Thus where the assist has been shown as a fluid assist arrangement, the fluid assist can be a hydraulic assist or a gas-based assist arrangement. Furthermore, where the prime drive is shown below as a fluid-based drive, e.g., a fluid-based pump or motor, e.g., a hydraulic pump or motor, the prime drive may be configured to operate based on gases, e.g., pneumatic-based devices.

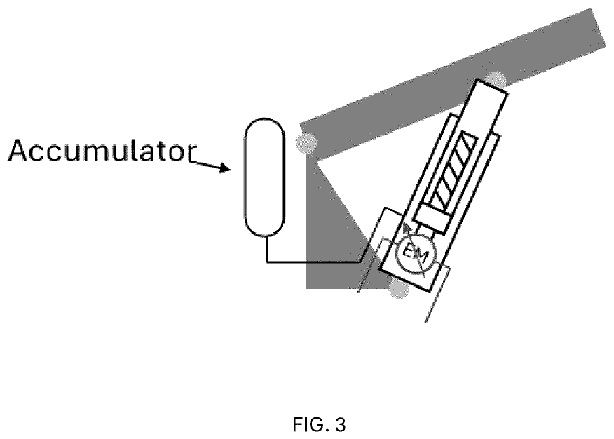

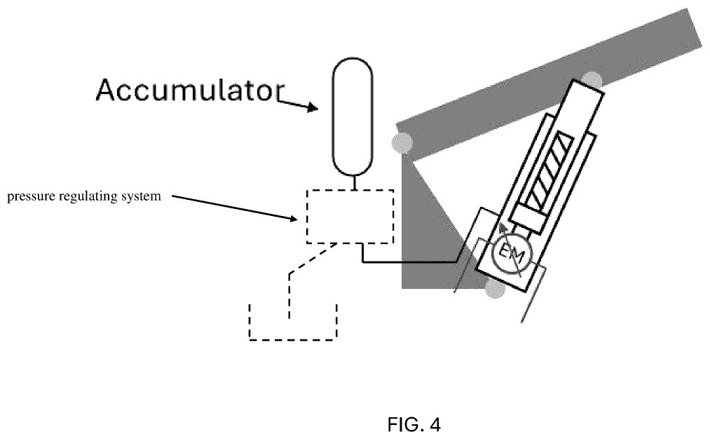

The assist line can be simply fluidly coupled to an accumulator to provide a constant pressure within the accumulator as the assist drive. Referring to FIG. 3, a schematic is shown with the embodiment shown in FIG. 2 in an application where the actuator of FIG. 2 is lifting a load with the assist line coupled to an accumulator and the electric motor is inside the housing. In the embodiment shown in FIG. 3, the accumulator is pre-charged with a predetermined pressure. As the electric motor rotates in the forward direction, the actuator lifts a load with the assist provided by the assist force according to the force balance concepts described above. As the load is let down, the potential energy is recuperated into the accumulator. While an accumulator is shown in FIG. 3, different assist circuits can be implemented. For example, referring to FIG. 4, an optional pressure regulating system is inserted between the assist port and the accumulator for improved pressure regulation. The pressure regulating system may include one or more of a pressure reducing valve or a pressure compensating valve, known to a person having ordinary skill in the art. The optional pressure regulating system includes a reservoir of fluid. These valves may be electronically controlled by a controller having a processor executing instructions housed on a non-transient memory. The controller may receive signals from one or more pressure sensors disposed in the housing (not shown) and configured to generate signals associated with the assist pressure based on the force balance concept described above.

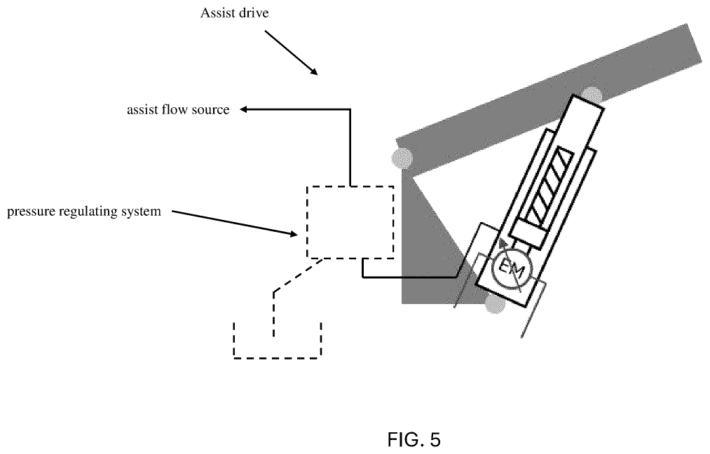

Referring to FIG. 5, the embodiment shown in FIG. 4 is provided with an assist flow source instead of the accumulator with an optional pressure regulating system as described with respect to FIG. 4. The assist drive then includes an optional pressure regulating system that can be integrated with the assist flow source, as is known to a person having ordinary skill in the art, in order to regulate pressure within the assist cylinder.

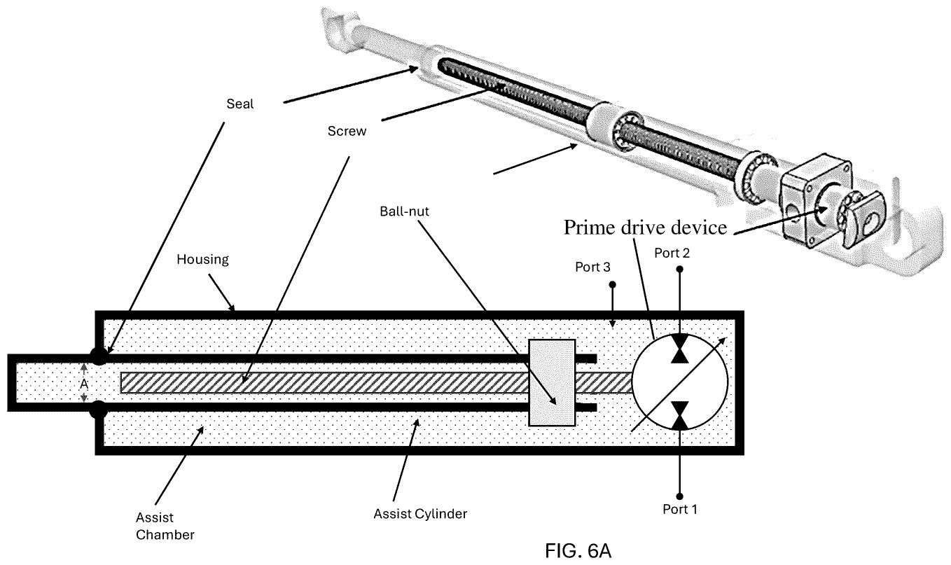

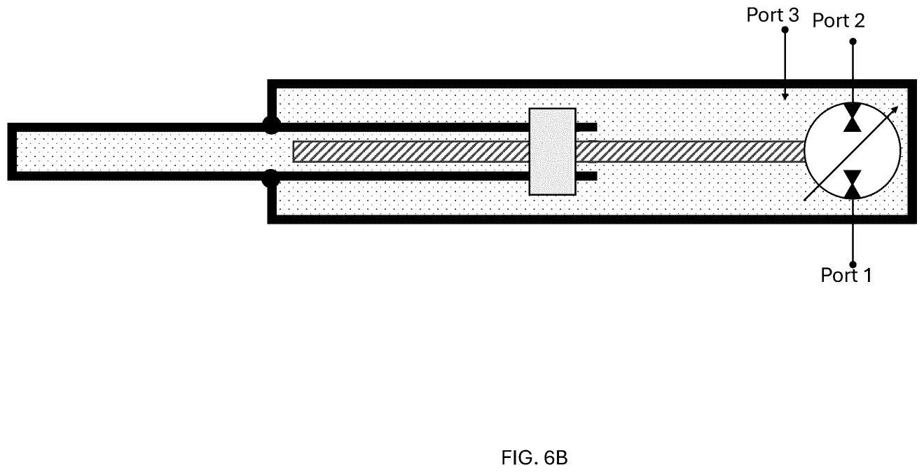

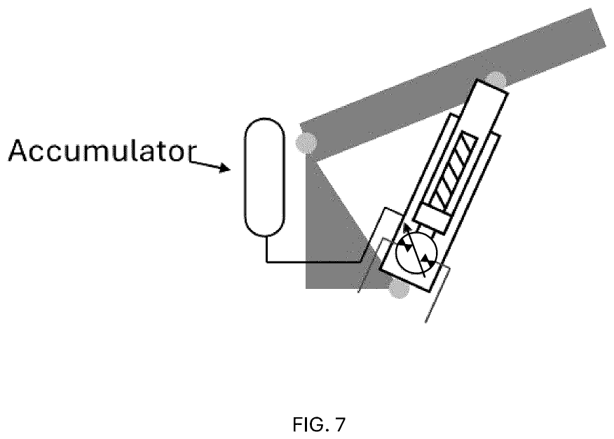

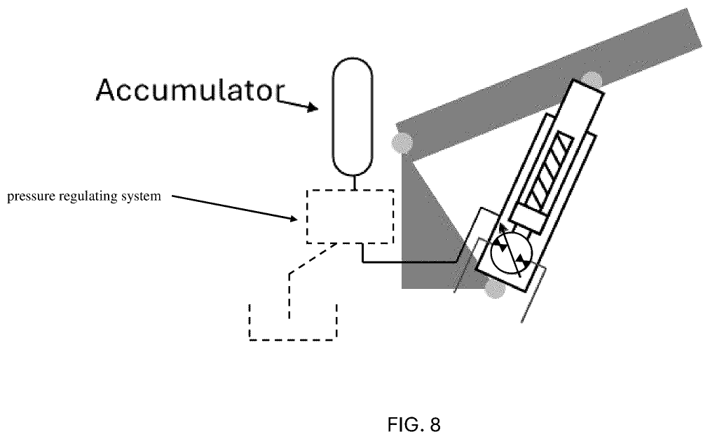

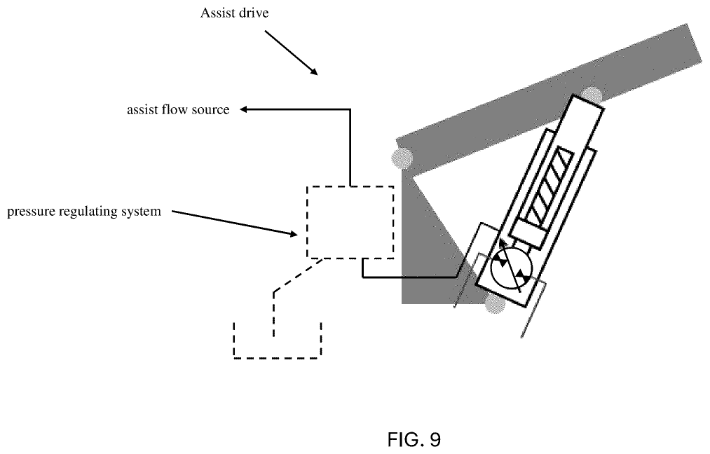

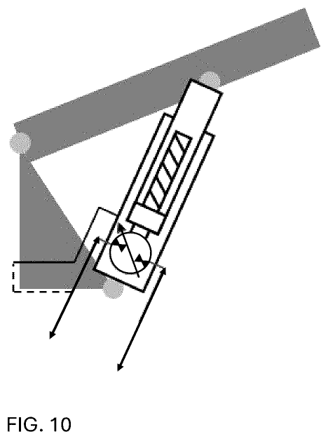

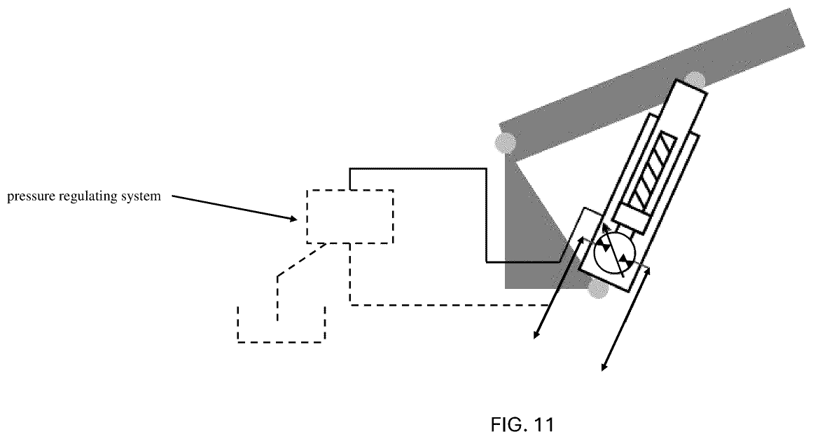

Referring to FIGS. 6A and 6B, the embodiment shown in FIG. 1D is provided with a hydraulic positive displacement machine for the prime drive and with an assist drive in retracted and extended positions, respectively. Therefore, there are three ports: ports 1 and 2 are for transference of fluid to the prime drive device and port 3 is for providing assist fluid into assist cylinder. The hydraulic positive displacement machine can be a variable displacement hydraulic pump/motor in which fluid volume passing through the machine controls the rectilinear displacement variables of the screw. The pump/motor may be configured to convert hydraulic energy to mechanical energy to perform work, e.g., lift a load, or convert mechanical energy to hydraulic energy, when the load is overrunning, i.e., load is descending, wherein the hydraulic energy can be recouped. The embodiment shown in FIGS. 6A and 6B can be used with any of assist drive arrangements shown in FIGS. 3-5. That is, the hydraulic port for providing the assist hydraulic pressure can be coupled to an accumulator directly as shown in FIG. 7 or via a pressure regulating system as shown in FIG. 8; or instead of an accumulator the hydraulic port for providing the assist pressure can be coupled to the assist flow source, as shown in FIG. 9 with the optional pressure regulating system, as is known to a person having ordinary skill in the art, to regulate pressure in the assist cylinder. Additionally, the schematic shown in FIGS. 6A and 6B can be used where the fluid for the prime drive is also used as the fluid in the assist drive, as shown in FIG. 10, i.e., where the accumulator is replaced by a coupling between one of ports 1 or 2 and port 3. Accordingly, the same fluid flow that operates the prime drive device, also provides the assist pressure within the assist cylinder. FIG. 11 is a schematic of FIG. 10 where the simple coupling between one of port 1 or 2 and port 3 is replaced with an optional pressure regulating system, as is known to a person having ordinary skill in the art, to regulate pressure in the assist cylinder.

In any of the embodiments the components of the prime drive can be placed outside the housing or alternatively can be placed inside the housing.

As discussed above, in any of the embodiments where an assist drive is incorporated only one fluid chamber is present requiring only one seal.

Furthermore, in any embodiments where an assist drive is presented, the screw that is turned by the prime drive is stationary. The screw turns inside the ball-nut that is solidly coupled to the assist cylinder, and the ball-nut and the assist cylinder rectilinearly extend or retract depending on the direction of motion of the screw in the ball-bit thus extending or retracting the load that is coupled to the end of the assist cylinder.

Those having ordinary skill in the art will recognize that numerous modifications can be made to the specific implementations described above. The implementations should not be limited to the particular limitations described. Other implementations may be possible.

1. An actuator, comprising:
a housing;
an assist cylinder forming a single hydraulic chamber at least partially disposed within the housing and configured to provide rectilinear motion with respect to the housing, wherein fluid within the assist cylinder is sealed from outside by a seal between the housing and the assist cylinder, the assist cylinder is configured to be coupled to a load to be moved;
a screw disposed within the housing and rotatably coupled to a ball-nut solidly coupled to the assist cylinder, such that rotation of the screw in a first direction causes the assist cylinder to advance forward and rotation of the screw in a second direction opposite the first directions causes the assist cylinder to retract backward;
a prime drive having an output that is coupled to the screw and configured to rotate the screw in the first and second directions; and
an assist drive fluidly coupled to the assist cylinder and configured to provide an assist fluid having an assist pressure against a cross sectional area of the assist cylinder to thereby generate an assist force to assist moving the assist cylinder.

2. The actuator of claim 1, wherein the assist drive includes an accumulator coupled to the assist cylinder that is pre-charged with the assist fluid at a predetermined pressure.

3. The actuator of claim 2, wherein the assist drive further includes a pressure regulating system having controllable valves disposed between the accumulator and the assist cylinder, the pressure regulating system is adapted to selectively adjust the assist pressure.

4. The actuator of claim 1, wherein the assist drive is coupled to an assist flow source and further coupled to a pressure regulating system coupled to the assist cylinder having controllable valves, the pressure regulating system is adapted to selectively adjust the assist pressure.

5. The actuator of claim 1, wherein the prime drive is an electrical motor.

6. The actuator of claim 1, wherein the prime drive is a fluid-based pump or motor with two ports for transference of prime drive fluid.

7. The actuator of claim 6, wherein the assist drive includes a fluid coupling between the assist cylinder and one of the two ports of prime drive, thereby the assist fluid and the prime drive fluid are at a common assist pressure.

8. The actuator of claim 7, wherein the assist drive further includes a pressure regulating system having controllable valves disposed between the assist cylinder and one of the two ports of prime drive, the pressure regulating system is adapted to selectively adjust the assist pressure.

9. An actuator, comprising:
a housing;
a screw at least partially disposed within the housing and rotatably coupled to a stationary ball-nut, such that rotation of the screw in a first direction causes the screw to advance forward and rotation of the screw in a second direction opposite the first directions causes the screw to retract backward, the screw is configured to be coupled to a load to be moved; and
a prime drive having an output that is coupled to the screw and configured to rotate the screw in the first and second directions, wherein the prime drive is a fluid-based pump or motor with two ports for transference of prime drive fluid.

10. The actuator of claim 9, wherein fluid of the prime drive is hydraulic fluid or gas.

11. A load moving system, comprising:
an actuator; and
a load coupling interface to a load to be moved,
the actuator includes:
a housing;
an assist cylinder forming a single hydraulic chamber at least partially disposed within the housing and configured to provide rectilinear motion with respect to the housing, wherein fluid within the assist cylinder is sealed from outside by a seal between the housing and assist cylinder, the assist cylinder is configured to be coupled to a load to be moved;
a screw disposed within the housing and rotatably coupled to a ball-nut solidly coupled to the assist cylinder, such that rotation of the screw in a first direction causes the assist cylinder to advance forward and rotation of the screw in a second direction opposite the first directions causes the assist cylinder to retract backward;
a prime drive having an output that is coupled to the screw and configured to rotate the screw in the first and second directions; and
an assist drive fluidly coupled to the assist cylinder and configured to provide an assist fluid having an assist pressure against a cross sectional area of the assist cylinder to thereby generate an assist force to assist moving the assist cylinder.

12. The load moving system of claim 11, wherein the assist drive includes an accumulator coupled to the assist cylinder that is pre-charged with the assist fluid at a predetermined pressure.

13. The load moving system of claim 12, wherein the assist drive further includes a pressure regulating system having controllable valves disposed between the accumulator and the assist cylinder, the pressure regulating system is adapted to selectively adjust the assist pressure.

14. The load moving system of claim 11, wherein the assist drive is coupled to an assist flow source and further coupled to a pressure regulating system coupled to the assist cylinder having controllable valves, the pressure regulating system is adapted to selectively adjust the assist pressure.

15. The load moving system of claim 11, wherein the prime drive is an electrical motor.

16. The load moving system of claim 11, wherein the prime drive is a fluid-based pump or motor with two ports for transference of prime drive fluid.

17. The load moving system of claim 16, wherein the assist drive includes a fluid coupling between the assist cylinder and one of the two ports of prime drive, thereby the assist fluid and the prime drive fluid are at a common assist pressure.

18. The load moving system of claim 17, wherein the assist drive further includes a pressure regulating system having controllable valves disposed between the assist cylinder and one of the two ports of prime drive, the pressure regulating system is adapted to selectively adjust the assist pressure.

19. The load moving system of claim 11, wherein the assist fluid is hydraulic fluid or gas.

20. The load moving system of claim 16, wherein fluid of the prime drive is hydraulic fluid or gas.
